(19) United States
(12) Patent Application Publication
(10) Pub. No.: US 2025/0114771 A1
(43) Pub. Date: Apr. 10, 2025

(54) METHOD FOR PRODUCING NOBLE METAL FINE PARTICLE-SUPPORTED CATALYST, METHOD FOR PRODUCING NOBLE METAL FINE PARTICLES, NOBLE METAL FINE PARTICLE-SUPPORTED CATALYST, AND NOBLE METAL FINE PARTICLES

(71) Applicant: TOYOTA BOSHOKU KABUSHIKI KAISHA, Aichi-ken (JP)

(72) Inventors: Hiroshi YANO, Aichi (JP); Kota IWASAKI, Aichi (JP)

(73) Assignee: TOYOTA BOSHOKU KABUSHIKI KAISHA, Aichi-ken (JP)

(21) Appl. No.: 18/986,857

(22) Filed: Dec. 19, 2024

Related U.S. Application Data
(62) Division of application No. 17/122,590, filed on Dec. 15, 2020.

(30) Foreign Application Priority Data
Dec. 18, 2019 (JP) 2019-227955

(51) Int. Cl. H01M 4/92; H01M 4/88

(52) U.S. Cl. CPC B01J 23/38; C01G 5/00; C01G 7/00; C01G 55/00; B82Y 30/00; B82Y 40/00

(57) ABSTRACT

A method for producing a noble metal fine particle-supported catalyst includes: a step of mixing a noble metal salt, an alcohol having 1 to 5 carbon atoms, and a support to form a mixture; and a heating step of the mixture at a temperature of 150° C. or higher and 800° C. or lower to produce a noble metal fine particle-supported catalyst.

### CROSS-REFERENCE TO RELATED APPLICATIONS

This application is a divisional of U.S. patent application Ser. No. 17/122,590, filed Dec. 15, 2020, which claims priority to Japanese Patent Application No. 2019-227955 filed on Dec. 18, 2019. The entire contents of each of the above-mentioned documents is hereby incorporated by reference in its entirety.

The present disclosure relates to a method for producing a noble metal fine particle-supported catalyst, a method for producing noble metal fine particles, a noble metal fine particle-supported catalyst, and noble metal fine particles.

### BACKGROUND OF THE INVENTION

Active metal-supported catalysts are applied in sensors, petroleum refining, hydrogen production, and other fields such as environment-related fields and energy fields. Among them, a polymer electrolyte fuel cell, which has been researched and developed in recent years as a power source for automobiles and stationary cogeneration, is given as a typical example. As an electrode catalyst, a catalyst obtained by using a conductive material such as carbon or an oxide as a support and supporting an active metal such as platinum, which has been miniaturized to a nanometer size, on the conductive material is used. The performance of the catalyst depends on the particle diameter of the active metal, the uniformity of the particle diameter, and the degree of dispersion on the support. In particular, when catalysts have the same amount of the active metal supported, a catalyst in which a particle diameter of the active metal is smaller (a surface area of the active metal is larger) and the active metal is more highly dispersed has higher performance. Further, since platinum is expensive, it is required to make its particle diameter smaller in order to reduce the amount of platinum used.

As a method for producing an electrode catalyst composed of active metal nanoparticles, for example, a technique of irradiating with microwaves a mixture that contains a precursor containing a noble metal element and a support having microwave absorption for the purpose of reduction, as shown in JP 2010-253408 A (Patent Document 1), is known. Further, a technique of reducing a chloroplatinic acid solution to prepare a metal colloidal solution and supporting it on a support, as in JP 2001-224968 A (Patent Document 2), is also known. In addition, a technique of dispersing an organometallic complex of an active metal and a metal chloride in an organic solvent, adding a reducing agent, and pressurizing and heating the mixture according to need to prepare a product, as in JP 2015-17317 A (Patent Document 3), is known. A technique of supporting platinum group nanoparticles whose particle diameter is controlled by using a dispersant such as a microemulsion dispersion (JP 2018-44245 A, Patent Document 4) or an amphipathic polymer (JP 2009-164142 A, Patent Document 5) has also been proposed. However, in all the cases, the number of catalyst synthesis steps is large, and waste liquid treatment is also included within the steps. Additionally, it is very difficult to make the particle diameter infinitely small, which is the main purpose, and the distribution width of the particle diameter is wide in a range of from 2 nm to a dozen nm.

In JP 2010-253408 A (Patent Document 1), particles of a noble metal are controlled by microwave heating. Therefore, the support material that absorbs microwaves is limited, and the heat generated from the support is non-uniform. Thus, the distribution width of the particle size is so wide that it is difficult to control the particle size.

In JP 2001-224968 A (Patent Document 2), it is difficult to control the particle diameter because the colloid is unstable. In JP 2015-17317 A (Patent Document 3), an attempt is made to control the particle diameter by pressurization, heating, etc., but the preparation process is complicated, and, additionally, there is a problem in the distribution of particle diameter.

Further, in JP 2018-44245 A (Patent Document 4) and JP 2009-164142 A (Patent Document 5), the particle diameter, including its distribution state, is controlled by a polymer agent. However, the particle diameter depends on the size of the emulsion produced by the dispersant, making it difficult to control small particles. Further, it is difficult to remove the polymer agent after reduction, which contributes to an increase in the number of steps.

The present disclosure has been made for solving at least a part of the above problems, and can be realized in the following forms.

### SUMMARY OF THE INVENTION

[1] A method for producing a noble metal fine particle-supported catalyst, including:
a step of mixing a noble metal salt, an alcohol having 1 to 5 carbon atoms, and a support to form a mixture; and
a heating step of the mixture at a temperature of 150° C. or higher and 800° C. or lower to produce a noble metal fine particle-supported catalyst.

According to the production method, a highly active noble metal fine particle-supported catalyst can be produced by a simplified method.

### BRIEF DESCRIPTION OF THE DRAWINGS

FIG. 1 is an explanatory diagram showing a comparison between the number of synthesis steps in Examples and the number of steps in each of the patent documents;

FIG. 2 is a chart which is referred to in the consideration of the validity of the definition of spherical form;

FIG. 3 is a convection voltammogram of a Pt 1.4 nm/C electrode (in O₂ saturation, 0.1M HClO₄ (30° C.));

FIG. 4 is a Koutecky-Levich plot by ORR at the Pt 1.4 nm/C electrode;

FIG. 5 is a TEM image of a catalyst synthesized in Example 3 (left) and a TEM image of a catalyst synthesized in Patent Document 1 (JP 2010-253408 A) (right);

FIG. 6 shows a TEM image of a catalyst synthesized in Example 1 and a particle diameter distribution of Pt particles;

FIG. 7 shows a TEM image of a catalyst synthesized in Example 2 and a particle diameter distribution of Pt particles;

FIG. 8 shows a TEM image of the catalyst synthesized in Example 3 and a particle diameter distribution of Pt particles;

FIG. 9 shows a TEM image of a catalyst synthesized in Example 4 and a particle diameter distribution of Pt particles;

FIG. 10 is a graph showing the relationship between the concentration of noble metal salts and the average particle diameter of Pt particles;

FIG. 11 is a graph showing the Pt particle size dependence of an ORR mass activity;

FIG. 12 shows a TEM image of a catalyst synthesized at a heating temperature of 130° C.;

FIG. 13 shows a TEM image of a catalyst synthesized at a heating temperature of 170° C.;

FIG. 14 shows a TEM image of a catalyst synthesized at a heating temperature of 200° C.;

FIG. 15 shows a TEM image of a catalyst synthesized at a heating temperature of 300° C.;

FIG. 16 shows a TEM image of a catalyst synthesized at a heating temperature of 400° C.;

FIG. 17 shows a TEM image of a catalyst synthesized at a heating temperature of 500° C.;

FIG. 18 shows a TEM image of a catalyst synthesized at a heating temperature of 600° C.;

FIG. 19 shows a TEM image of a catalyst synthesized at a heating temperature of 200° C. in an argon atmosphere and a particle diameter distribution of Pt particles;

FIG. 20 shows a TEM image of a catalyst synthesized at a heating temperature of 200° C. in the air and a particle diameter distribution of Pt particles;

FIG. 21 shows a TEM image of a catalyst synthesized using a tetraammineplatinum (II) chloride hydrate and a particle diameter distribution of Pt particles; and

FIG. 22 shows a TEM image of a catalyst synthesized using a hexachloroplatinic (IV) acid hexahydrate and a particle diameter distribution of Pt particles.

### DETAILED DESCRIPTION

Here, other examples of the present disclosure are presented.
[2] The method for producing a noble metal fine particle-supported catalyst, wherein a concentration of the noble metal salt in an alcohol solution in which the noble metal salt is dissolved is 0.1 mol L⁻¹ or more and 50 mol L⁻¹ or less.

According to the production method, a noble metal fine particle-supported catalyst having a small particle diameter and high activity can be produced.
[3] The method for producing a noble metal fine particle-supported catalyst, wherein an average particle diameter of the noble metal fine particles is 0.7 nm or more and less than 2 nm.

According to the production method, a noble metal fine particle-supported catalyst having a small particle diameter and high activity can be produced.
[4] A method for producing noble metal fine particles, including:
a step of mixing a noble metal salt and an alcohol having 1 to 5 carbon atoms to form a mixture; and
a heating step of the mixture at a temperature of 150° C. or higher and 800° C. or lower to produce noble metal fine particles.

According to the production method, highly active noble metal fine particles can be produced by a simplified method.
[5] The method for producing noble metal fine particles, wherein a concentration of the noble metal salt in an alcohol solution in which the noble metal salt is dissolved is 0.1 mol L⁻¹ or more and 50 mol L⁻¹ or less.

According to the production method, noble metal fine particles having a small particle diameter and high activity can be produced.
[6] The method for producing noble metal fine particles, wherein an average particle diameter of the noble metal fine particles is 0.7 nm or more and less than 2 nm.

According to the production method, noble metal fine particles having a small particle diameter and high activity can be produced.
[7] A noble metal fine particle-supported catalyst in which noble metal fine particles are supported on a support,
wherein an average particle diameter of the noble metal fine particles is 0.7 nm or more and less than 2 nm.
The noble metal fine particle-supported catalyst has high activity.
[8] Noble metal fine particles having an average particle diameter of 0.7 nm or more and less than 2 nm.

The noble metal fine particles have high activity.

Hereinafter, embodiments of the present disclosure will be described in detail. In addition, in the present specification, a phrase about a numerical range using the word “to” includes a lower limit value and an upper limit value unless otherwise specified. For example, the phrase “10 to 20” includes both the lower limit “10” and the upper limit “20”. That is, the phrase “10 to 20” has the same meaning as “10 or more and 20 or less”.

### 1. Method for Producing Noble Metal Fine Particle-Supported Catalyst

A method for producing a noble metal fine particle-supported catalyst of the present disclosure includes: a step of mixing a noble metal salt, an alcohol having 1 to 5 carbon atoms, and a support to form a mixture; and a heating step of the mixture at a temperature of 150° C. or higher and 800° C. or lower to produce a noble metal fine particle-supported catalyst.

### (1) Noble Metal Salt

The noble metal contained in the noble metal salt is not particularly limited, but at least one selected from the group consisting of platinum (Pt), palladium (Pd), rhodium (Rh), gold (Au), silver (Ag), iridium (Ir), and ruthenium (Ru) is preferably used. Among these noble metals, at least one selected from the group consisting of Pt, Pd, Rh, Ir, and Ru is more preferred, and at least one selected from the group consisting of Pt and Pd is further preferred, from the viewpoint of catalytic performance.

As the noble metal salt, at least one selected from the group consisting of hexachloroplatinic (IV) acid hexahydrate (H₂PtCl₆·6H₂O), tetraamminedichloroplatinum (Pt(NH₃)₄Cl₂·xH₂O), platinum bromide (IV) (PtBr₄), and bis(acetylacetonato)platinum (II) ([Pt(C₅H₇O₂)₂]) can preferably be used.

### (2) Alcohol Having 1 to 5 Carbon Atoms

As the alcohol having 1 to 5 carbon atoms, at least one selected from the group consisting of methanol, ethanol, propanol, isopropyl alcohol, 1-butanol, 2-butanol, t-butyl alcohol, 1-pentanol, and 3-pentanol can preferably be used. Among these alcohols, ethanol is preferred from the viewpoint of reducing the environmental load.

The amount ratio of the alcohol to the noble metal salt is not particularly limited. The concentration of the noble metal salt in an alcohol solution in which the noble metal salt is dissolved is not particularly limited. The concentration of the noble metal salt is preferably 0.1 mol L⁻¹ or more and 50 mol L⁻¹ or less, more preferably 5 mol L⁻¹ or more and 40 mol L⁻¹ or less, and further preferably 10 mol L⁻¹ or more and 30 mol L⁻¹ or less, from the viewpoint of producing highly active noble metal fine particles having a particle diameter of 0.7 nm to 2 nm and a uniform size.

### (3) Support

The support is not particularly limited as long as it can support the noble metal fine particles. As the support, at least one selected from carbon black, amorphous carbon, carbon nanotubes, carbon nanohorns, and one or more metal oxides selected from rare earths, alkaline earths, transition metals, niobium, bismuth, tin, antimony, zirconium, molybdenum, indium, tantalum, and tungsten can preferably be used. Among these supports, carbon black is preferred from the viewpoint of surface area.

When carbon black is used as the support, the nitrogen adsorption specific surface area of carbon black is not particularly limited. The nitrogen adsorption specific surface area of carbon black is preferably 10 m²g⁻¹ or more and 1800 m²g⁻¹ or less, and more preferably 150 m²g⁻¹ or more and 800 m²g⁻¹ or less, from the viewpoint of supporting noble metal fine particles.

### (4) Mixing Ratio of Support to Alcohol

The mixing ratio of the support to the alcohol is not particularly limited. From the viewpoint of fully blending the support and the alcohol into highly active noble metal fine particles having a particle diameter of 0.7 nm to 2 nm and a uniform size, the support is preferably mixed at a ratio of 2 mg or more and 200 mg or less, more preferably mixed at a ratio of 10 mg or more and 100 mg or less, and further preferably mixed at a ratio of 30 mg or more and 80 mg or less, per mL of the alcohol.

### (5) Mixing

The mixing method is not particularly limited. Pulverization mixing may be performed using a mortar and a pestle. For example, pulverization mixing may be performed using a dry crusher such as a ball mill, a vibration mill, a hammer mill, a roll mill, or a jet mill. For example, mixing may be performed using a mixer such as a ribbon blender, a Henschel mixer, or a V-type blender.

The mixing time is not particularly limited. Mixing is preferably performed until the alcohol volatilizes so that the mixture dries.

### (6) Heating

The heating temperature is 150° C. or higher and 800° C. or lower, preferably 150° C. or higher and 400° C. or lower, and more preferably 150° C. or higher and 250° C. or lower, from the viewpoint of producing highly active noble metal fine particles having a particle diameter of 0.7 nm to 2 nm and a uniform size.

Heating is preferably performed in an atmosphere of an inert gas. As the inert gas, a rare gas such as argon gas or nitrogen gas can preferably be used. Heating may be performed in air.

### (7) Average Particle Diameter of Noble Metal Fine Particles

The average particle diameter of the noble metal fine particles is not particularly limited. The average particle diameter of the noble metal fine particles is preferably 0.7 nm or more and less than 2 nm, and more preferably 1.2 nm or more and 1.6 nm or less, from the viewpoint of increasing the activity.

The average particle diameter can be determined by the following method (way to determine the average particle diameter). A synthesized catalyst is observed by a transmission electron microscope (TEM). The TEM photograph is printed out on paper. The noble metal fine particles (black circular images) are regarded as spherical, and the length from end to end of each of the noble metal fine particles is regarded as diameter. A total of 300 particles are randomly measured from images of several fields of view (3 to 5 fields of view). The average of the diameters of the counted 300 particles is defined as average particle diameter.

Further, the noble metal fine particles preferably have a standard deviation value of 0% or more and 20% or less with respect to the average particle diameter value. The standard deviation value is calculated by creating a distribution map from the diameters of the 300 particles.

### (8) Effect of Production Method of the Present Embodiment

The production method of the present embodiment is a production method which enables production of an ultrafine and highly active metal-supported catalyst by a very simple technique of mixing a noble metal salt and a support material in a highly volatile alcohol (for example, ethanol) and heat-treating the mixture, and which is environment-friendly because it does not generate any waste liquid in the producing process.

Further, the production method of the present embodiment can be used to produce a noble metal fine particle-supported catalyst in which a highly active metal composed of nano-level structures, whose particle diameter can be controlled extremely accurately within the range of 0.7 nm and 2 nm only by the concentration of the noble metal salt and which have a uniform size, is highly dispersed and supported on a support such as carbon. This noble metal fine particle-supported catalyst is extremely useful as an electrode catalyst.

Further, since the active metal has a particle diameter of 2 nm or less and is highly dispersed and supported on the support in the noble metal fine particle-supported catalyst produced by the production method of the present embodiment, the metal utilization rate is high at the atomic level, and high performance is achieved. Therefore, the noble metal fine particle-supported catalyst is suitable, for example, as an electrode catalyst for a polymer electrolyte fuel cell used as a power source for households or automobiles for which reduction in the amount of noble metal used is required. The catalyst exhibits 10 times higher activity than that of a conventional product (Pt/C catalyst in which Pt nanoparticles of about 3 nm are supported on carbon).

### 2. Method for Producing Noble Metal Fine Particles

The method for producing noble metal fine particles of the present disclosure includes:
a step of mixing a noble metal salt and an alcohol having 1 to 5 carbon atoms to form a mixture; and
a heating step of the mixture at a temperature of 150° C. or higher and 800° C. or lower to produce noble metal fine particles.

### (1) Incorporation of Explanation

The above descriptions of “(1) Noble metal salt”, “(2) Alcohol having 1 to 5 carbon atoms”, “(5) Mixing”, “(6) Heating”, and “(7) Average particle diameter of noble metal fine particles” explained in “1. Method for producing noble metal fine particle-supported catalyst” are applied to the method for producing noble metal fine particles of the present disclosure as they are, and these descriptions are omitted.

### (2) Effect of Production Method of the Present Embodiment

The production method of the present embodiment is a production method which enables production of ultrafine and highly active metal fine particles by a very simple technique of mixing a highly volatile alcohol (for example, ethanol) and a noble metal salt and heat-treating the mixture, and which is environment-friendly because it does not generate any waste liquid in the producing process.

Further, the production method of the present embodiment can be used to produce highly active noble metal fine particles composed of nano-level structures whose particle diameter can be controlled extremely accurately within the range of 0.7 nm and 2 nm only by the concentration of the noble metal salt and which have a uniform size. These noble metal fine particles are extremely useful in an electrode catalyst.

Further, since the active metal has a particle diameter of 2 nm or less in the noble metal fine particles produced by the production method of the present embodiment, the metal utilization rate is high at the atomic level, and high performance is achieved. Therefore, the noble metal fine particles are suitable, for example, for an electrode catalyst for a polymer electrolyte fuel cell used as a power source for households or automobiles for which reduction in the amount of noble metal used is required. The catalyst exhibits 10 times higher activity than that of a conventional product (Pt/C catalyst in which Pt nanoparticles of about 3 nm are supported on carbon).

### 3. Noble Metal Fine Particle-Supported Catalyst

In the noble metal fine particle-supported catalyst of the present disclosure, noble metal fine particles are supported on a support. The average particle diameter of the noble metal fine particles is 0.7 nm or more and less than 2 nm. The noble metal fine particle-supported catalyst can be produced by “1. Method for producing noble metal fine particle-supported catalyst”.

### (1) Incorporation of Explanation

The above descriptions of “noble metal” in “(1) Noble metal salt”, “(3) Support”, and “way to determine the average particle diameter” in “(7) Average particle diameter of noble metal fine particles” explained in “1. Method for producing noble metal fine particle-supported catalyst” are applied to the noble metal fine particle-supported catalyst of the present disclosure as they are, and these descriptions are omitted.

### (2) Amount of Noble Metal Supported

The amount of the noble metal supported is not particularly limited, and a required amount of the noble metal may appropriately be supported in response to the target design and the like. From the viewpoint of catalyst performance and cost, the amount of the noble metal supported is preferably 5 parts by mass or more and 50 parts by mass or less, and more preferably 10 parts by mass or more and 30 parts by mass or less, in terms of metal, per 100 parts by mass of the support.

### (3) Effect of Noble Metal Fine Particle-Supported Catalyst of the Present Embodiment

The noble metal fine particle-supported catalyst of the present embodiment can be produced by a very simple technique of mixing a noble metal salt and a support material in a highly volatile alcohol (for example, ethanol) and heat-treating the mixture, and can also be produced by an environment-friendly production method which does not generate any waste liquid in the producing process.

Since the noble metal fine particle-supported catalyst of the present embodiment has an average particle diameter of 0.7 nm or more and less than 2 nm, the metal utilization rate is high at the atomic level, and high performance is achieved. Therefore, the noble metal fine particle-supported catalyst is suitable, for example, as an electrode catalyst for a polymer electrolyte fuel cell used as a power source for households or automobiles for which reduction in the amount of noble metal used is required. The catalyst exhibits 10 times higher activity than that of a conventional product (Pt/C catalyst in which Pt nanoparticles of about 3 nm are supported on carbon).

### 4. Noble Metal Fine Particles

The noble metal fine particles of the present disclosure have an average particle diameter of 0.7 nm or more and less than 2 nm. The noble metal fine particles can be produced by the above “2. Method for producing noble metal fine particles”.

### (1) Incorporation of Explanation

The above descriptions of “noble metal” in “(1) Noble metal salt” and “the way to determine the average particle diameter” in “(7) Average particle diameter of noble metal fine particles” explained in “1. Method for producing noble metal fine particle-supported catalyst” are applied to the noble metal fine particles of the present disclosure as they are, and these descriptions are omitted.

### (2) Effect of Noble Metal Fine Particles of the Present Embodiment

The noble metal fine particles of the present embodiment can be produced by a very simple technique of mixing a noble metal salt and a highly volatile alcohol (for example, ethanol) and heat-treating the mixture, and can also be produced by an environment-friendly production method which does not generate any waste liquid in the producing process.

Since the noble metal fine particles of the present embodiment have an average particle diameter of 0.7 nm or more and less than 2 nm, the metal utilization rate is high at the atomic level, and high performance is achieved. Therefore, the noble metal fine particles are suitable, for example, for an electrode catalyst for a polymer electrolyte fuel cell used as a power source for households or automobiles for which reduction in the amount of noble metal used is required.

### Examples

The present invention will be described more specifically by way of Examples.

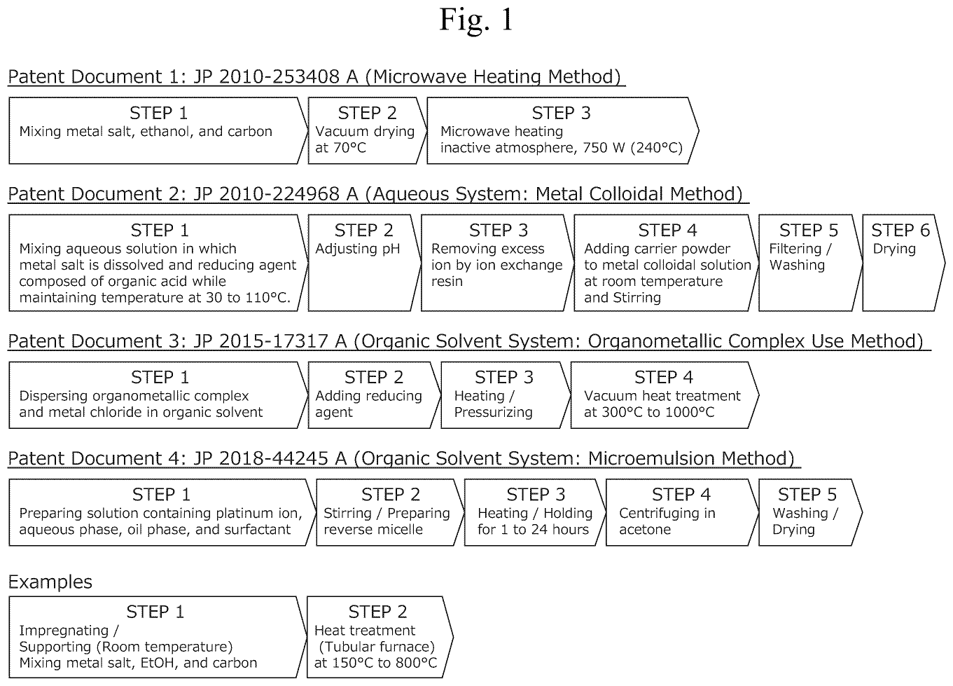

FIG. 1 shows a comparison between the number of steps in Examples and the number of steps in each of the patent documents. It can be seen that the Examples have the smallest number of steps. Another feature is that the production method of the Examples is an environment-friendly production method that does not generate any waste liquid because it does not use any organic substance or aqueous solution other than a volatile alcohol in the producing process.

### 1. Synthesis of Noble Metal Fine Particle-Supported Catalyst

Hexachloroplatinic (IV) acid hexahydrate (H₂PtCl₆·6H₂O: Kanto Chemical Co., Inc., 98.5%) was collected in a beaker in an amount as shown in Table 1 below, and ethanol (C₂H₅OH) was added thereto in an amount as shown in Table 1 below to dissolve hexachloroplatinic (IV) acid hexahydrate. After collection of 85.6 g of graphitized carbon black (GCB, specific surface area of 150 m²g⁻¹: LION) in a mortar, an ethanol solution in which the above Pt salt was dissolved was added thereto, and the mixture was stirred and mixed until ethanol volatilized to dryness. The obtained powder was transferred to a ceramic boat and heat-treated in an argon (Ar) (atmosphere at 200° C. for 2 hours in a tubular furnace. After the temperature was lowered to room temperature, the heat-treated powder was taken out from the tubular furnace and evaluated as a catalyst.

TABLE 1

| | | | | Particle |
|---|---|---|---|---|
| | H₂PtCl₆•6H₂O | EtOH | [H₂PtCl₆•6H₂O] | size, d |
| Examples | (mg) | (mL) | (mol L⁻¹) | (nm) |
| 1 | 60.4 | 25.0 | 4.7 | 1.1 |
| 2 | 30.7 | 5.0 | 11.9 | 1.2 |
| 3 | 62.0 | 5.0 | 23.9 | 1.4 |
| 4 | 62.0 | 2.5 | 47.9 | 1.8 |

### 2. Way to Determine Particle Diameter Distribution (Average Particle Diameter and Standard Deviation of Particle Diameter Distribution)

Synthesized Pt particles (noble metal fine particles) were observed by a transmission electron microscope (TEM). The TEM photograph was printed out on paper. The Pt particles (black circular images) were regarded as spherical, and the length from end to end of each of the Pt particles was regarded as diameter. A total of 300 particles were randomly measured from images of several fields of view (3 to 5 fields of view). A value obtained by averaging the diameters of the counted 300 particles was defined as average particle diameter. In addition, a distribution map was created from the particle diameters of the 300 particles to calculate the standard deviation value. The distribution width of the particle diameter of the synthesized Pt particles was very narrow, and the standard deviation value was between 0 and 20% of the average particle diameter value.

### 3. Validity of Definition of Spherical Form

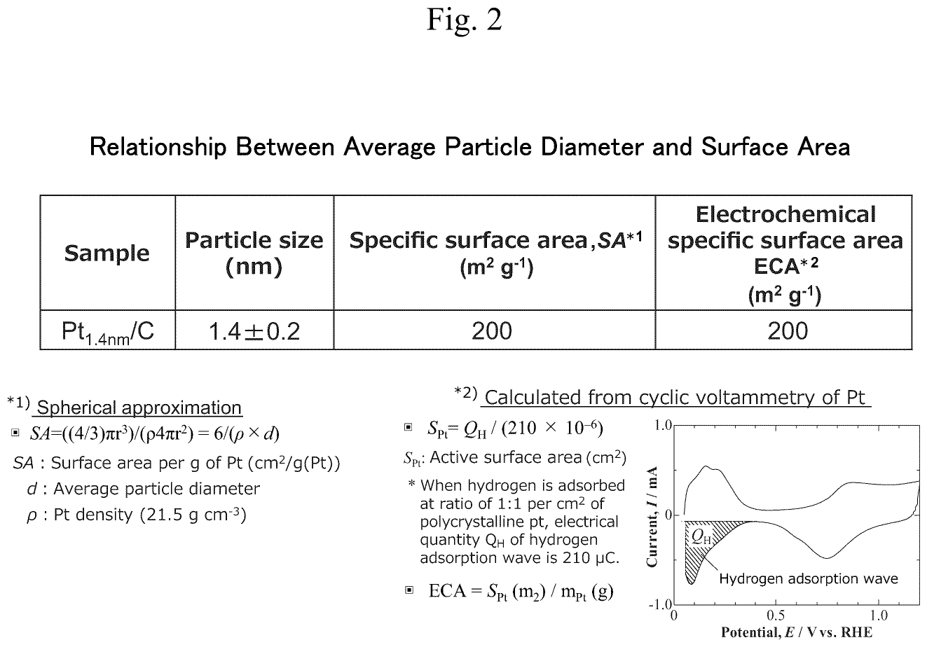

As an example, a Pt_{1.4 nm}/C catalyst having an average particle diameter d=1.4 nm in Example 3 will be described (see FIG. 2).

First, Pt particles are defined as spherical, and the specific surface area (SA) of the spheres is calculated from Equation (3.1) with the value of the average particle diameter as the radius.

$$SA = ( ( 4 / 3 ) π {r}^{3} ) / ( ρ 4 π {r}^{2} ) = 6 / ( ρ \times d ) \qquad ( 3.1 )$$

From this, when the average particle diameter is d=1.4 nm, SA=200 m²g⁻¹.

On the other hand, there is a technique of determining the specific surface area from an electrochemical reaction (area that is actually active as a fuel cell reaction). FIG. 2 shows a cyclic voltammogram (CV, potential-current curve, 0.05V to 1.0V) of a general Pt electrode measured in a 0.1M HClO₄ solution degassed with Ar. Here, when one hydrogen atom is adsorbed on one Pt atom per cm² of Pt, the electrical quantity Q_{H} in the shaded region (hydrogen adsorption wave) in the figure is defined as 210 μC.

Then, an appropriate amount of Pt_{1.4 nm}/C catalyst is dispersed and fixed on an electrode substrate, and CV is measured in the same manner using it as a working electrode. The hydrogen adsorption wave region at this time is integrated to determine the electrical quantity Q_{H}. Since the electrical quantity of 210 μC flows per cm² of Pt, the surface area S_{Pt} (m²) of the Pt 1.4 nm/C catalyst that actually contributes to the reaction can be calculated from Equation (3.2). The electrochemical specific surface area ECA can be calculated by dividing the obtained S_{Pt} value by the mass (m_{Pt}) of Pt placed on the electrode substrate, as shown in Equation (3.3).

$${S}_{Pt} = {Q}_{H} ( C ) / 210 ( C / {m}^{2} ) \qquad ( 3.2 )$$

$$ECA = {S}_{Pt} ( {m}^{2} ) / {m}_{Pt} ( g ) \qquad ( 3.3 )$$

Here, since the specific surface area value (SA=200 m²g⁻¹) of the spheres and the electrochemical specific surface area value (ECA=200 m²g⁻¹) match, the synthesized Pt particles can be considered as spherical.

### 4. Way to Determine Oxygen Reduction Reaction (ORR) Mass Activity

4.1. Formation of Pt/C Catalyst into Electrode

A predetermined amount of Pt/C (e.g., 2 mg) is ultrasonically dispersed in ethanol (e.g., 2 mL). This solution is used as a catalyst ink.

The electrode substrate is a glassy carbon disc (+5, geometric area: 0.196 cm²). An appropriate amount of catalyst ink is dropped onto the surface of the substrate to disperse and support the catalyst.

After drying, a 0.2 wt % Nafion solution (dry film thickness: 0.1 μm) is added dropwise. The catalyst layer is covered on the substrate. This product is used as a working electrode.

Also in the CV measurement in the above “3. Validity of definition of spherical form”, the catalyst is formed into an electrode by the same method.

### 4.2 Rotating Disc Electrode (RDE) Method

The measurement principle is described at the following URL.

https://www.bas.co.jp/xdata/200706 mail news/hydrodyn amic voltammetry with rde and rrde.pdf

The above electrode was used as a working electrode. An ORR reaction was carried out in an 02-saturated 0.1 M perchloric acid (HClO₄) solution (30° C.) to evaluate the activity.

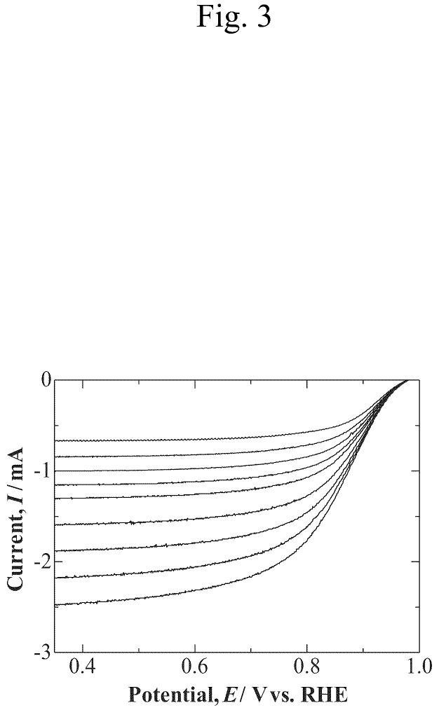

First, the convection voltammogram is measured by sweeping the potential from 0.3V to 1.0 V (vs. reversible hydrogen electrode (RHE)) while changing the rotation speed of the electrode. FIG. 3 shows a convection voltammogram of a Pt_{1.4 nm}/C electrode of Example 3.

Since ORR is a reaction system (irreversible system) in which the electron transfer rate that occurs on the electrode surface is slow, the active control current (Iₖ) from which the effect of mass transfer is removed can be determined by the following equation (Koutecky-Levich equation).

$$1 / I = 1 / {I}_{k} + 1 / ( 0.62 {nFSD}^{2 / 3} {C}_{O} {v}^{- 1 / 6} {ω}^{1 / 2} )$$

wherein n is the number of reaction electrons, F is the Faraday constant, S is the electrochemically active surface area, D is the diffusion coefficient of O₂, C_{O} is the oxygen solubility, υ is the viscosity of the electrolytic solution, and ω is the angular velocity.

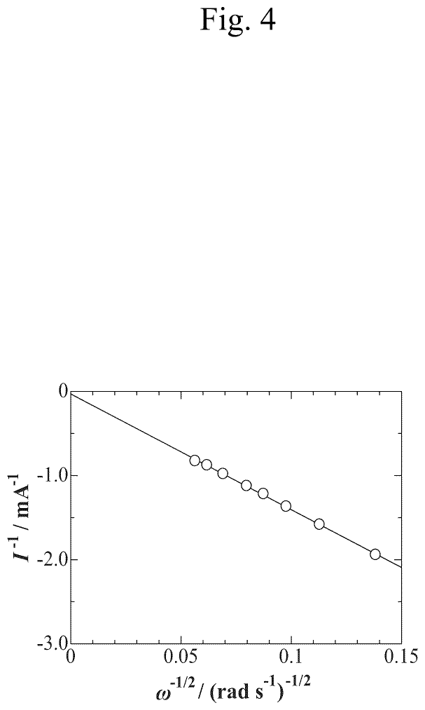

FIG. 4 shows the results of plotting the reciprocal I⁻¹ of the current I at 0.85 V obtained by the ORR voltammogram in FIG. 3 against ω^{-1/2} (Koutecky-Levich plot). Here, the current value Iₖ governed by kinetics can be obtained from the intercept obtained by extrapolating a straight line (ω^{-1/2} being made 0) so that the rotation speed (diffusion speed of oxygen) is infinite. The mass activity MAₖ (Ag_{Pt}⁻¹) can be determined by dividing the obtained Iₖ by the mass m (g) of Pt.

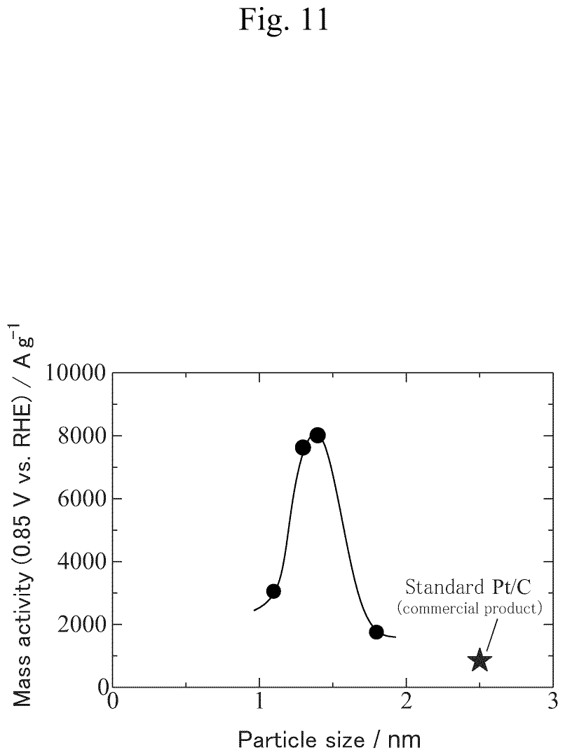

FIG. 11, which will be described below, shows a plot of the mass activity MAₖ value of the Pt_{dnm}/C catalyst of each average particle diameter determined in this manner against the particle size.

### 5. Experimental Results

5.1 Observation with Transmission Electron Microscope (Comparison with Patent Document 1 (JP 2010-253408 A))

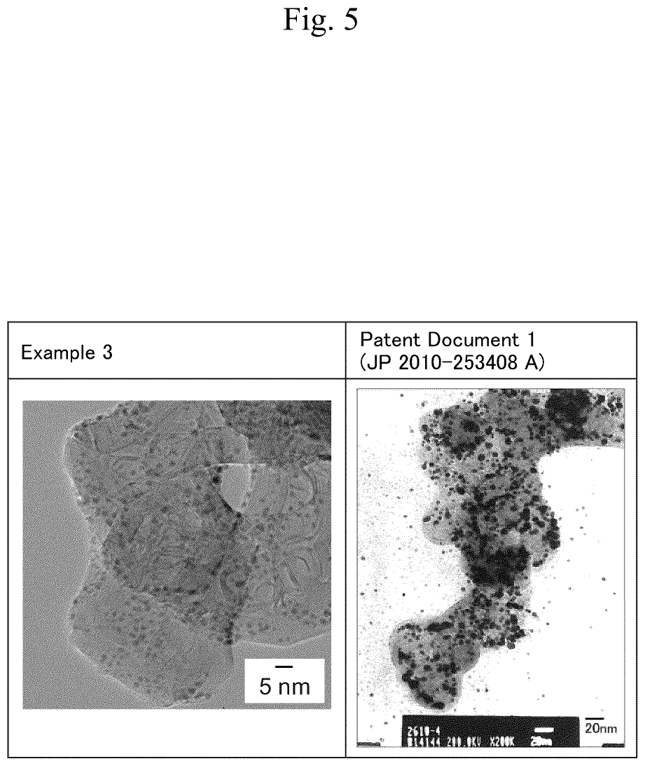

The present invention is characterized in that it is possible to synthesize an electrode catalyst in which a highly active metal composed of nano-level structures having a uniform particle size is highly dispersed and supported on a support such as carbon. The left figure of FIG. 5 shows a catalyst image of the catalyst synthesized in Example 3, which was taken with a transmission electron microscope (TEM). The right figure of FIG. 5 shows a catalyst image synthesized in Patent Document 1, which was taken by a transmission electron microscope (TEM).

In the TEM image of Patent Document 1, as compared with the catalyst synthesized in Example 3, the size of the Pt particles (black dots) on carbon (gray part) varies, the dispersed state is poor, and there are many places where the particles are aggregated. In this way, when the particles of the active metal are controlled to be small, the distribution width is usually widened so that the particles are likely to be aggregated. Further, in such a state, the performance as a catalyst is significantly deteriorated.

### 5.2 Relationship Between Concentration of Noble Metal Salt and Average Particle Diameter of Noble Metal Fine Particles

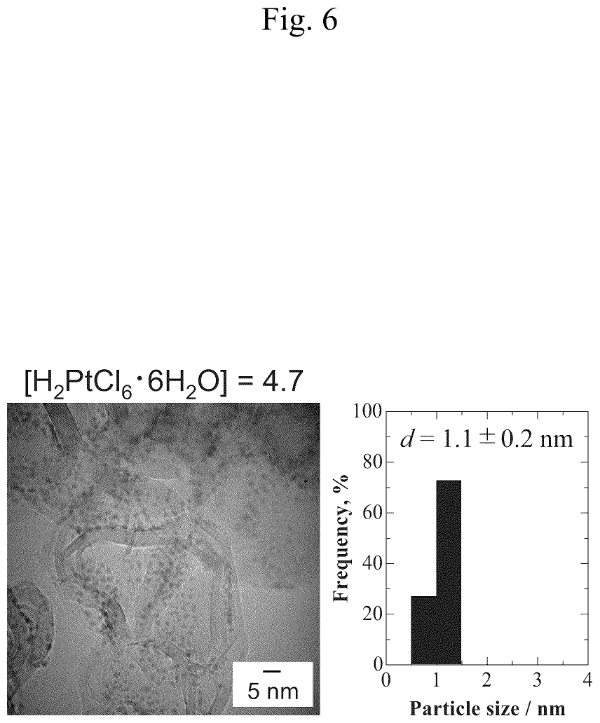

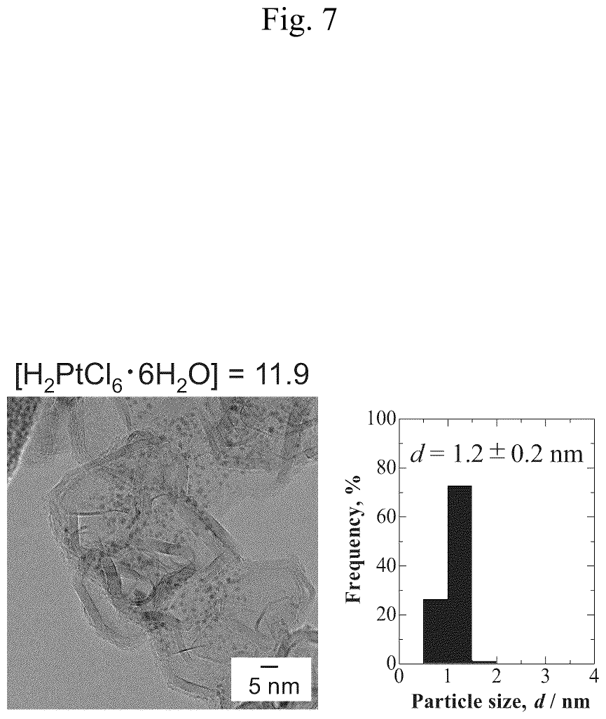

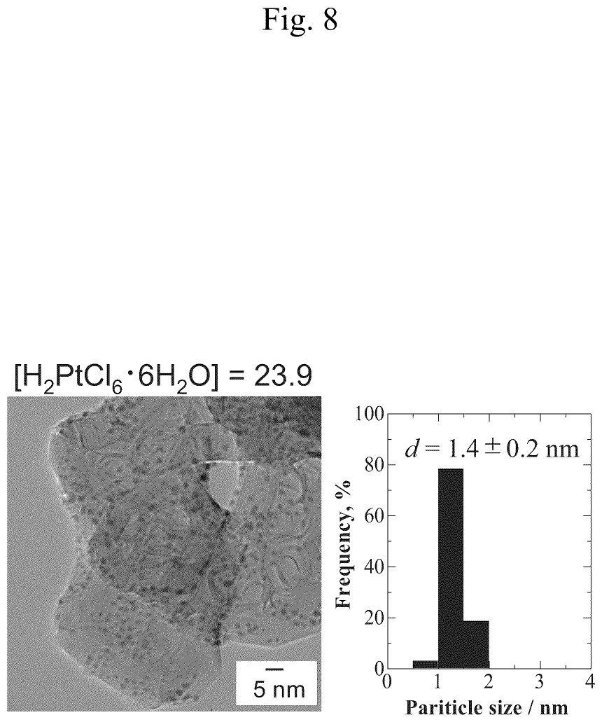

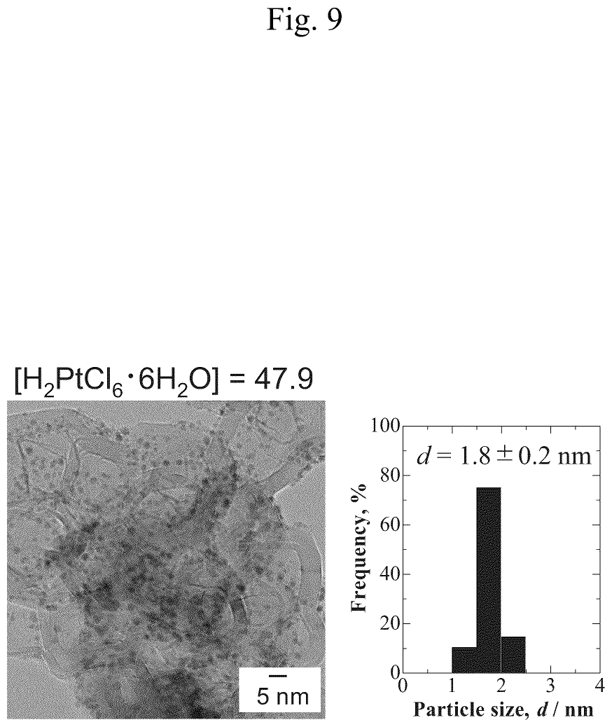

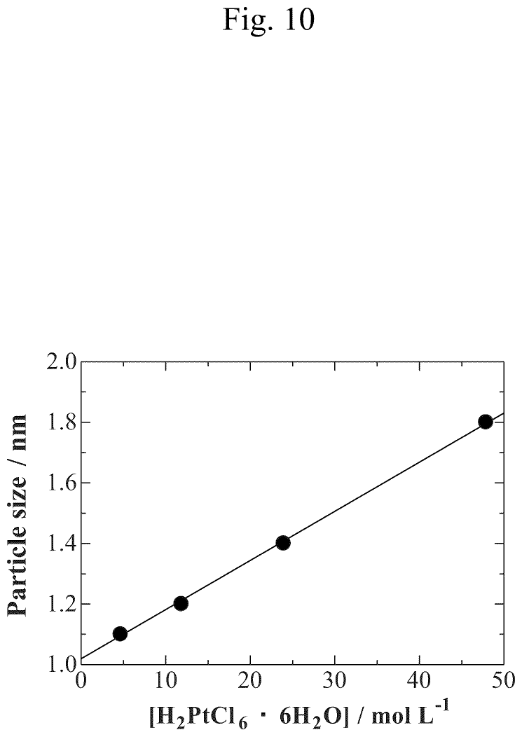

In the Examples, it was confirmed that when only the noble metal reagent concentration (noble metal salt concentration) is controlled while all other conditions during synthesis (heat treatment temperature: 200° C., atmosphere: in inert gas) are the same, the average particle diameter can be controlled extremely accurately within the range of 0.7 nm and 2 nm. In all of the techniques described in the patent documents, the particle size ranges from 2 nm to a dozen nm, which is larger than that of the catalyst particles of the Examples. It is a feature of the present invention that particles of about 1 nm can be easily controlled and synthesized. FIGS. 6 to 9 show the TEM images and particle diameter distributions of the respective Pt particles when synthesized at the reagent concentrations shown in Table 1, as Examples 1 to 4. It can be seen that Pt nanoparticles are monodisperse-supported in all the four types of catalysts, and that the particle diameter distribution width is very narrow. The relationship between the average particle diameter calculated from this distribution and the Pt salt concentration during synthesis is shown in FIG. 10. Since the relationship shows good linearity, it was proved that particles having any size of 2 nm or less can be prepared.

### 5.3 ORR Mass Activity

In the catalyst produced in the present invention, since the active metal can be controlled to have a particle diameter of 2 nm or less and is highly dispersed and supported on the support, the metal utilization rate is high at the atomic level, and high performance is achieved. Thus, the catalyst can be used, for example, as an electrode catalyst for a polymer electrolyte fuel cell (PEFC) used as a power source for households or automobiles for which reduction in the amount of noble metal used is required. Then, the activity of the oxygen reduction reaction (ORR) when the catalyst was used as a catalyst for an air electrode of PEFC was investigated. FIG. 11 shows the results of evaluating the ORR activity in oxygen-saturated 0.1 M perchloric acid (30° C.). The ORR current value (mass activity) per Pt mass at 0.85 V with respect to the particle size (average particle diameter) of Pt particles is shown in the figure. It was confirmed that the mass activity greatly depended on the particle size within the range of 1 to 2 nm and showed the maximum value at around 1.4 nm (1.2 nm to 1.6 nm), and that the catalyst produced in the present invention exhibited the activity higher than that of a commercially available platinum catalyst (about 800 Ag⁻¹) of standard Pt/C (3 nm or more) used in PEFC and the activity reached maximally 10 times (that is, the amount of Pt used was reduced to 1/10).

### 6. Effect of Heating Temperature in Heating Process

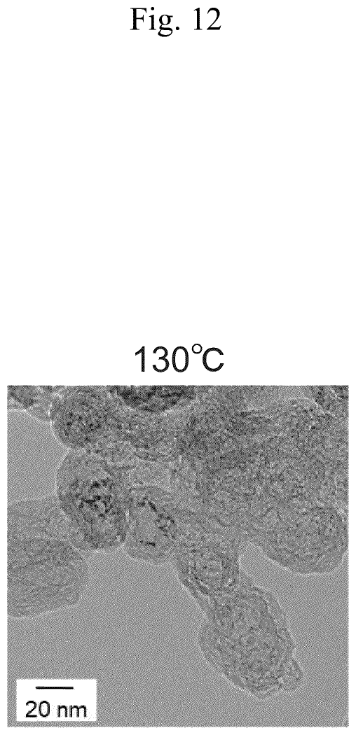

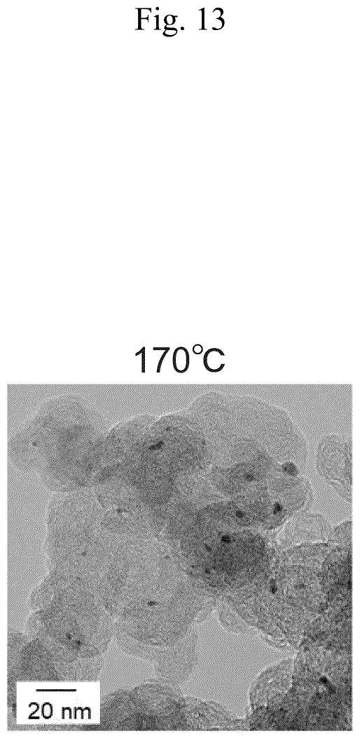

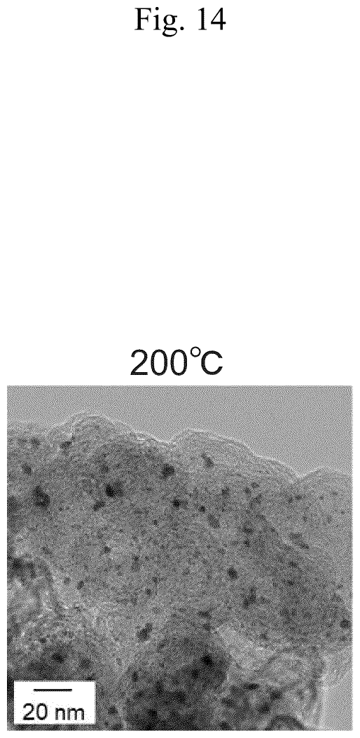

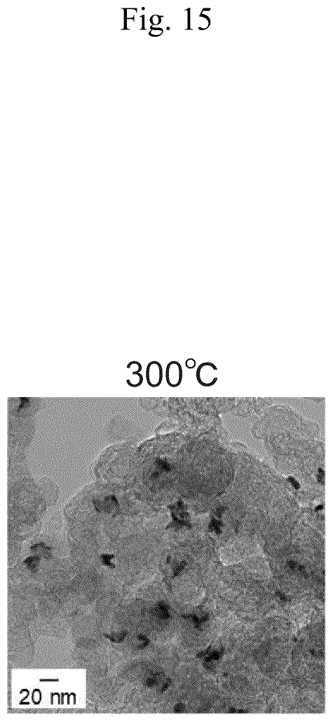

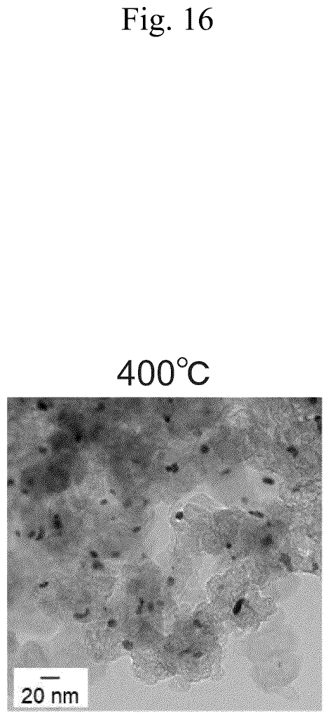

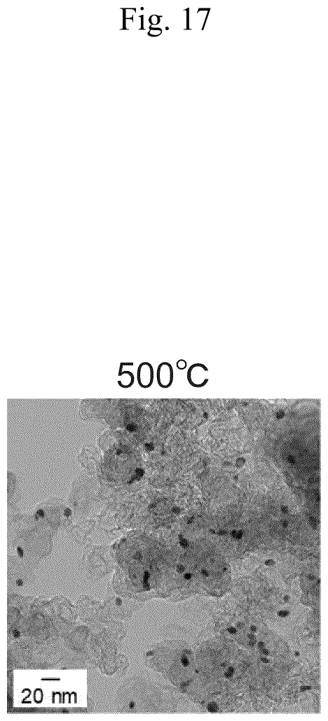

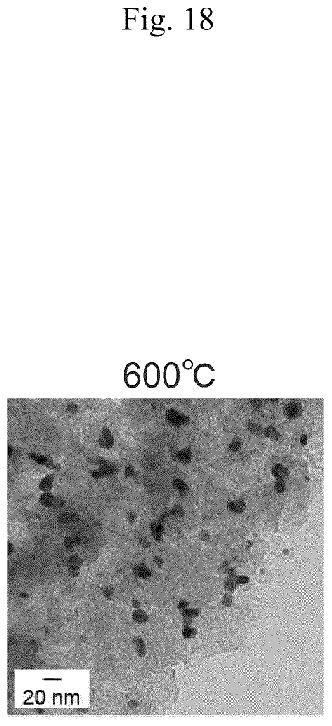

The effect of the heating temperature in the heating process was investigated. FIGS. 12 to 18 show TEM images of the catalyst after heat treatment for 2 hours at each predetermined heating temperature between 130° C. and 600° C. in the same manner as in Example 3 except for the heating temperature. It was confirmed that Pt particles were formed at 150° C. or higher. At 150° C. or higher and 250° C. or lower, Pt particles having an average particle diameter of 1 to 2 nm were formed. Aggregation of secondary particles started at around 300° C., and coarsened particles were also observed at 400° C. to 500° C. From the above observation results, it was found that particle formation occurs at 150° C. or higher, that it is preferable to suppress the heating temperature to 400° C. or lower, and further that the most suitable condition is 150° C. or higher and 250° C. or lower.

### 7. Effect of Atmosphere in Heating Process

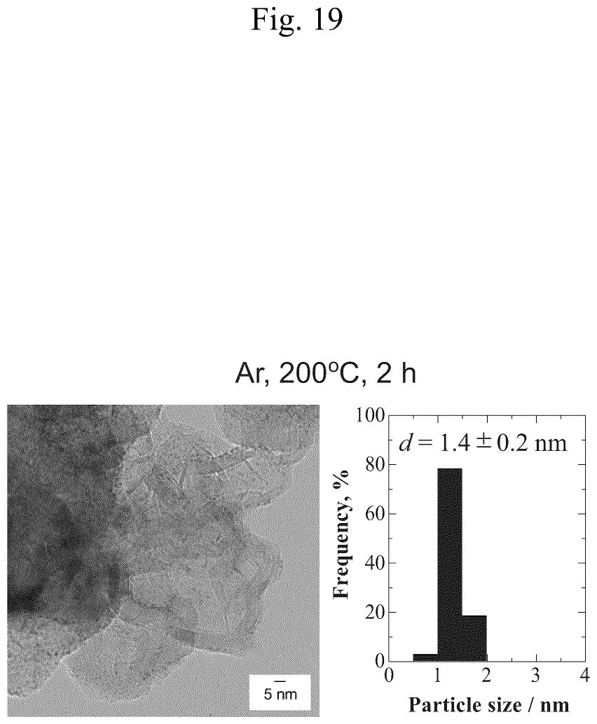

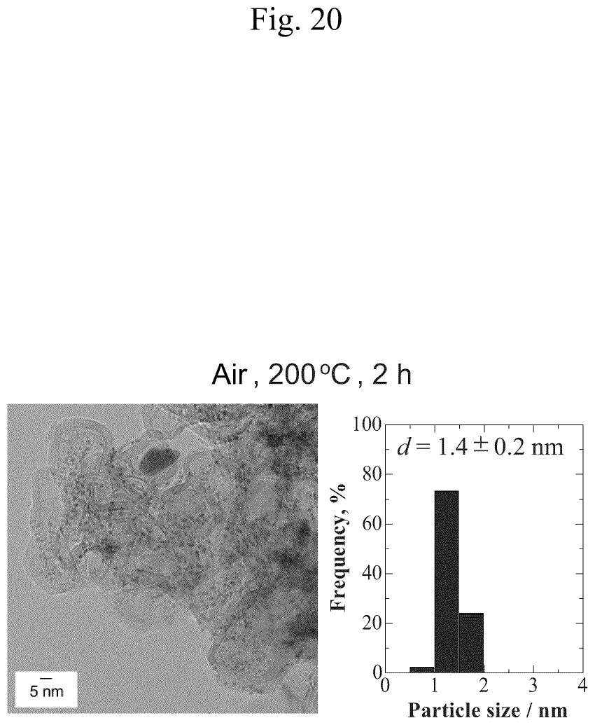

The influence of the atmosphere in the heating process was investigated. As an example, FIGS. 19 and 20 show TEM images of the catalyst when heat-treated (200° C., 2 hours) in argon (inert gas) and air under the same conditions as in Example 3. Although there were some parts that were slightly coarsened in air, the proportion of the coarsened parts was so low that the parts hardly affected the catalytic performance. Therefore, the desired catalyst in which Pt particles of 1 to 2 nm were highly dispersed was obtained in both the atmospheres. Not only in argon, but also in an inert gas (for example, nitrogen), there was no effect.

### 8. Effect of Type of Noble Metal Salt

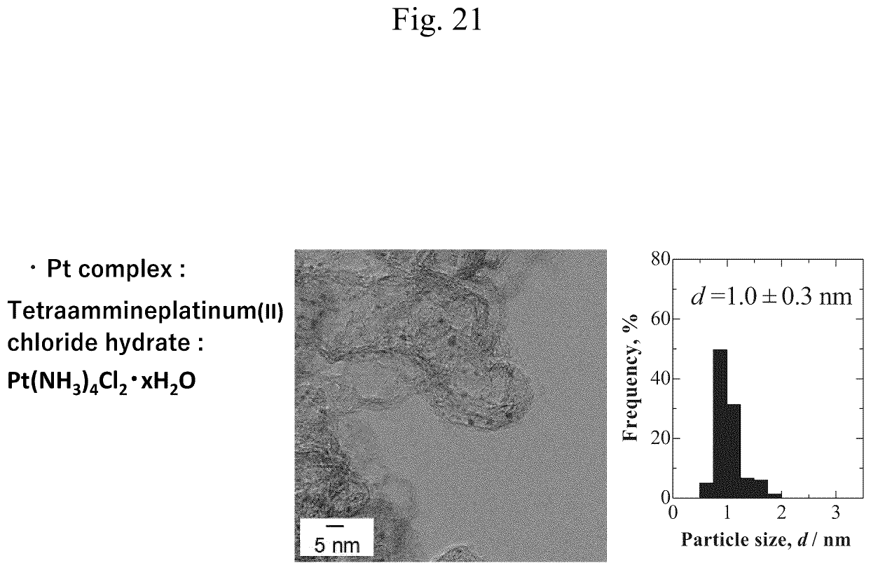

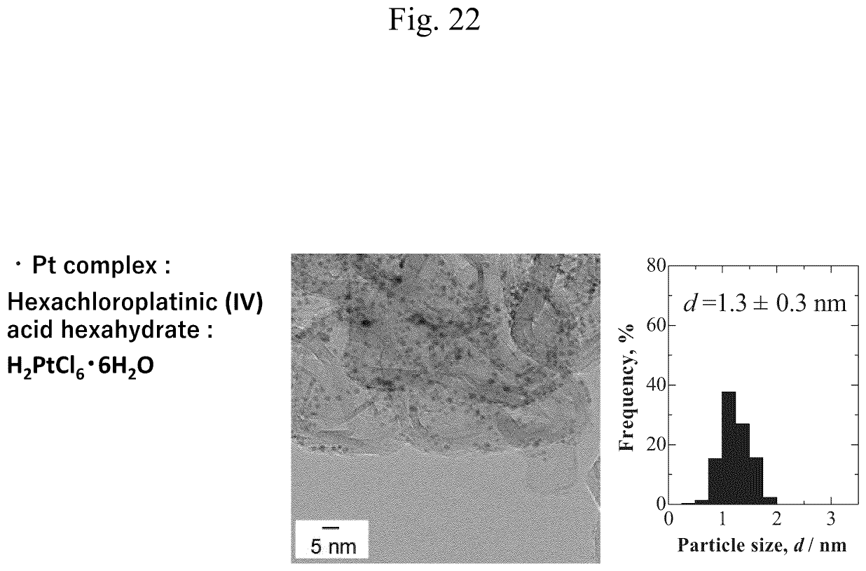

A catalyst was synthesized under the same conditions as in Example 3 using the noble metal salts having the concentrations shown in Table 2. FIGS. 21 and 22 show TEM images of the catalysts synthesized in Examples 5 and 6 and particle diameter distributions of Pt particles thereof.

It was confirmed that a catalyst in which platinum particles of about 1 nm are highly dispersed and supported on carbon can be prepared, whichever of the two platinum salts, tetraammineplatinum (II) chloride hydrate; Pt(NH₃)₄Cl₂·xH₂O and hexachloroplatinic (IV) acid hexahydrate; H₂PtCl₆·6H₂O, is used.

TABLE 2

| | | | | Noble metal | |
|---|---|---|---|---|---|
| | | Noble | | salt | |
| | Noble | metal | | concen- | Particle |
| | metal | salt | EtOH | tration | size, d |
| Examples | salt | (mg) | (mL) | (mol L⁻¹) | (nm) |
| 5 | Pt(NH₃)₄Cl₂•xH₂O | 19.4 | 40 | 0.5 | 1.0 |
| 6 | H₂PtCl₆•6H₂O | 62 | 5.0 | 23.9 | 1.3 |

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the scope of the appended claims, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, which are within the scope of the appended claims.

The present invention is not limited to the embodiments described in detail above, and can be modified or changed in various manners within the scope as set forth in the claims of the present invention.

1. A method for producing a noble metal fine particle-supported catalyst, the method comprising:
a step of mixing a noble metal salt, an alcohol having 1 to 5 carbon atoms, and a support to form a mixture; and
a heating step of the mixture at a temperature of 150° C. or higher and 800° C. or lower to produce a noble metal fine particle-supported catalyst.

2. The method for producing a noble metal fine particle-supported catalyst according to claim 1, wherein a concentration of the noble metal salt in an alcohol solution in which the noble metal salt is dissolved is 0.1 mol L⁻¹ or more and 50 mol L⁻¹ or less.

3. The method for producing a noble metal fine particle-supported catalyst according to claim 1, wherein an average particle diameter of the noble metal fine particles is 0.7 nm or more and less than 2 nm.

4. The method for producing a noble metal fine particle-supported catalyst according to claim 2, wherein an average particle diameter of the noble metal fine particles is 0.7 nm or more and less than 2 nm.

5. A method for producing noble metal fine particles, comprising:
a step of mixing a noble metal salt and an alcohol having 1 to 5 carbon atoms to form a mixture; and
a heating step of the mixture at a temperature of 150° C. or higher and 800° C. or lower to produce noble metal fine particles.

6. The method for producing noble metal fine particles according to claim 5, wherein a concentration of the noble metal salt in an alcohol solution in which the noble metal salt is dissolved is 0.1 mol L⁻¹ or more and 50 mol L⁻¹ or less.

7. The method for producing noble metal fine particles according to claim 5, wherein an average particle diameter of the noble metal fine particles is 0.7 nm or more and less than 2 nm.

8. The method for producing noble metal fine particles according to claim 6, wherein an average particle diameter of the noble metal fine particles is 0.7 nm or more and less than 2 nm.
